(19) United States
(12) Patent Application Publication
(10) Pub. No.: US 2017/0042754 A1
(43) Pub. Date: Feb. 16, 2017

(54) APPARATUS AND METHOD FOR SELF-REGULATING THERAPEUTIC PRESSURE MASSAGE

(71) Applicants: Pamela Fowers, Fair Oaks, CA (US); Brooks Davis, Rescue, CA (US); Kenneth Black, Sacramento, CA (US)

(72) Inventors: Pamela Fowers, Fair Oaks, CA (US); Brooks Davis, Rescue, CA (US); Kenneth Black, Sacramento, CA (US)

(21) Appl. No.: 14/827,053

(22) Filed: Aug. 14, 2015

(51) Int. Cl. A61H 7/00

(52) U.S. Cl. CPC A61H 7/001

(57) ABSTRACT

An apparatus and method for self-regulating therapeutic pressure massage are disclosed. An example embodiment includes an apparatus comprising: a handle; a force self-regulating mechanism captured with the handle; a rod in contact with the force self-regulating mechanism at a first end of the rod, the rod compressing the force self-regulating mechanism when force is applied to the handle; and a tip attached to a second end of the rod.

### TECHNICAL FIELD

The disclosed subject matter relates to the field of pressure massage therapy, and particularly to an apparatus and method for self-regulating therapeutic pressure massage.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the disclosure provided herein and to the drawings that form a part of this document: Copyright 2012-2015, Pamela Fowers, Brooks Davis, and Kenneth Black; All Rights Reserved.

### BACKGROUND

Massage therapy includes the manipulation of the soft tissues of the body for therapeutic purposes. A system of strokes is used, including gliding, kneading, friction, pressure and vibrating. In addition, massage therapists may use auxiliary mechanical devices. Massage can provide several benefits to the body such as increased blood flow, reduced muscle tension and neurological excitability, increase muscle compliance resulting in increased range of joint motion, decreased passive or active stiffness and increase or decrease neural excitability. Changes in parasympathetic activity and hormonal levels following massage result in a relaxation response.

Massage utilizes various techniques to manipulate muscle and connective tissue to relieve tension, improve joint mobility and aid in the healing process. Massage can be performed with the hands, or with a variety of tools that increase the amount of pressure applied to the body to create a more effective massage. Massage tools function by applying force through the tool to the body. However, massage therapists who are not trained in proper massage technique may apply excessive force with a massaging tool, which may cause soreness, pain, or injury. Massage tools are available that can measure the force being applied to the body. But, these conventional massage tools cannot automatically self-regulate the level of force being applied and thereby avoid pain or injury to the massage patient.

### BRIEF DESCRIPTION OF THE DRAWINGS

Embodiments are illustrated by way of example and not limitation in the figures of the accompanying drawings, in which:

FIG. 1 illustrates a front and rear view of an apparatus for self-regulating therapeutic pressure massage according to an example embodiment;

FIG. 2 illustrates a perspective view of an apparatus for self-regulating therapeutic pressure massage according to an example embodiment;

FIG. 3 illustrates a left and right side view of an apparatus for self-regulating therapeutic pressure massage according to an example embodiment;

FIG. 4 illustrates a bottom view of an apparatus for self-regulating therapeutic pressure massage according to an example embodiment;

FIG. 5 illustrates a cutaway perspective view of an apparatus for self-regulating therapeutic pressure massage according to an example embodiment;

FIG. 6 illustrates a perspective view of an alternative embodiment of the apparatus for self-regulating therapeutic pressure massage with a T-shaped handle according to an example embodiment;

FIG. 7 illustrates a front and rear view of an alternative embodiment of the apparatus for self-regulating therapeutic pressure massage with a T-shaped handle according to an example embodiment;

FIG. 8 illustrates a top view of an alternative embodiment of the apparatus for self-regulating therapeutic pressure massage with a T-shaped handle according to an example embodiment;

FIG. 9 illustrates a bottom view of an alternative embodiment of the apparatus for self-regulating therapeutic pressure massage with a T-shaped handle according to an example embodiment;

FIG. 10 illustrates a left and right side view of an alternative embodiment of the apparatus for self-regulating therapeutic pressure massage with a T-shaped handle according to an example embodiment;

FIG. 11 illustrates a cutaway front view of an alternative embodiment of the apparatus for self-regulating therapeutic pressure massage with a T-shaped handle according to an example embodiment;

FIG. 12 illustrates a perspective view of an alternative embodiment of the apparatus for self-regulating therapeutic pressure massage with an L-shaped handle according to an example embodiment;

FIG. 13 illustrates a front and rear view of an alternative embodiment of the apparatus for self-regulating therapeutic pressure massage with an L-shaped handle according to an example embodiment;

FIG. 14 illustrates a top view of an alternative embodiment of the apparatus for self-regulating therapeutic pressure massage with an L-shaped handle according to an example embodiment;

FIG. 15 illustrates a bottom view of an alternative embodiment of the apparatus for self-regulating therapeutic pressure massage with an L-shaped handle according to an example embodiment;

FIG. 16 illustrates a left and right side view of an alternative embodiment of the apparatus for self-regulating therapeutic pressure massage with an L-shaped handle according to an example embodiment;

FIG. 17 illustrates a cutaway front view of an alternative embodiment of the apparatus for self-regulating therapeutic pressure massage with an L-shaped handle according to an example embodiment;

FIG. 18 is a flow chart illustrating an example embodiment of a method as described herein;

FIG. 19 illustrates an alternative of the front and rear view of an apparatus for self-regulating therapeutic pressure massage according to an example embodiment;

FIG. 20 illustrates an alternative of the perspective view of an apparatus for self-regulating therapeutic pressure massage according to an example embodiment;

FIG. 21 illustrates an alternative of the left and right side view of an apparatus for self-regulating therapeutic pressure massage according to an example embodiment;

FIG. 22 illustrates an alternative of the bottom view of an apparatus for self-regulating therapeutic pressure massage according to an example embodiment;

FIG. 23 illustrates an alternative of the cutaway perspective view of an apparatus for self-regulating therapeutic pressure massage according to an example embodiment;

FIG. 24 illustrates a perspective view of an alternative embodiment of the apparatus for self-regulating therapeutic pressure massage wherein the force self-regulating mechanism replaces the rod according to an example embodiment;

FIG. 25 illustrates a front and rear view of an alternative embodiment of the apparatus for self-regulating therapeutic pressure massage wherein the force self-regulating mechanism replaces the rod according to an example embodiment;

FIG. 26 illustrates a top view of an alternative embodiment of the apparatus for self-regulating therapeutic pressure massage wherein the force self-regulating mechanism replaces the rod according to an example embodiment;

FIG. 27 illustrates a bottom view of an alternative embodiment of the apparatus for self-regulating therapeutic pressure massage wherein the force self-regulating mechanism replaces the rod according to an example embodiment;

FIG. 28 illustrates a left and right side view of an alternative embodiment of the apparatus for self-regulating therapeutic pressure massage wherein the force self-regulating mechanism replaces the rod according to an example embodiment;

FIG. 29 illustrates a perspective view of an alternative embodiment of the apparatus for self-regulating therapeutic pressure massage providing an externally-accessible, lever-actuated force self-regulating mechanism according to an example embodiment;

FIG. 30 illustrates a front and rear view of an alternative embodiment of the apparatus for self-regulating therapeutic pressure massage providing an externally-accessible, lever-actuated force self-regulating mechanism according to an example embodiment;

FIG. 31 illustrates a top view of an alternative embodiment of the apparatus for self-regulating therapeutic pressure massage providing an externally-accessible, lever-actuated force self-regulating mechanism according to an example embodiment;

FIG. 32 illustrates a bottom view of an alternative embodiment of the apparatus for self-regulating therapeutic pressure massage providing an externally-accessible, lever-actuated force self-regulating mechanism according to an example embodiment; and

FIG. 33 illustrates a left and right side view of an alternative embodiment of the apparatus for self-regulating therapeutic pressure massage providing an externally-accessible, lever-actuated force self-regulating mechanism according to an example embodiment.

### DETAILED DESCRIPTION

In the following detailed description, reference is made to the accompanying drawings that form a part hereof, and in which are shown, by way of illustration, specific embodiments in which the disclosed subject matter can be practiced. It is understood that other embodiments may be utilized and structural changes may be made without departing from the scope of the disclosed subject matter.

According to various example embodiments of the disclosed subject matter as described herein, there are disclosed and claimed an apparatus and method for self-regulating therapeutic pressure massage. The various embodiments as described herein can be used for applying a therapeutic pressure massage for relieving sore muscles. In example embodiments, the apparatus comprises a T-shaped or L-shaped handle with a rod and an internal force self-regulating mechanism. The rod includes a rounded, rubberized tip on the end that applies pressure to the body from the force self-regulating mechanism. The force self-regulating mechanism provides varying rates of pressure to specific regions of the body, thereby reducing pain, soreness, and immobility. The various example embodiments described herein help relieve tension in tight, spastic, and sore muscles, improves joint mobility, and reduces fatigue and stress associated with prolonged body aches and pain.

In many cases, the conventional massage devices are geared toward using an object for the massage therapist to conserve their energy (e.g., a device to replace the therapist's hand contact). Other conventional devices for use by the individual person can be a generally hand-held, but hard device used to push against the muscle to break it or force it into submission. This can be a very painful process. The various example embodiments as disclosed herein are designed to influence soft tissue (e.g., muscles, tendons, ligaments, and the like) to relax as opposed to forcing it. A gentle and specific touch or application of the device disclosed herein to a painful area of the body can comfortably influence the soft tissue to relax.

An important element of the embodiments disclosed herein is the force self-regulating mechanism, which enables this painless approach to getting the soft tissue to relax or reduce tension allowing it to move more toward homeostasis, which allows the person to feel more relaxed, and the joints to move more freely. With the force self-regulating mechanism as disclosed herein, a person can vary the pressure applied to a part of the body utilizing a biofeedback loop from the point of application to the brain, applying just enough pressure to get the desired result, but not so much pressure as to cause resistance or pain. The force self-regulating mechanism as disclosed herein operates to absorb pressure and self-regulate the level of force applied to the body, which serves to relieve tension and de-activate soft tissue in a way that conventional massage devices cannot provide. With the embodiments as disclosed herein, when pressure is applied to the body, the force self-regulating mechanism actually serves to soften or absorb the contact, thereby allowing the soft tissue to relax or de-activate in a more comfortable manner.

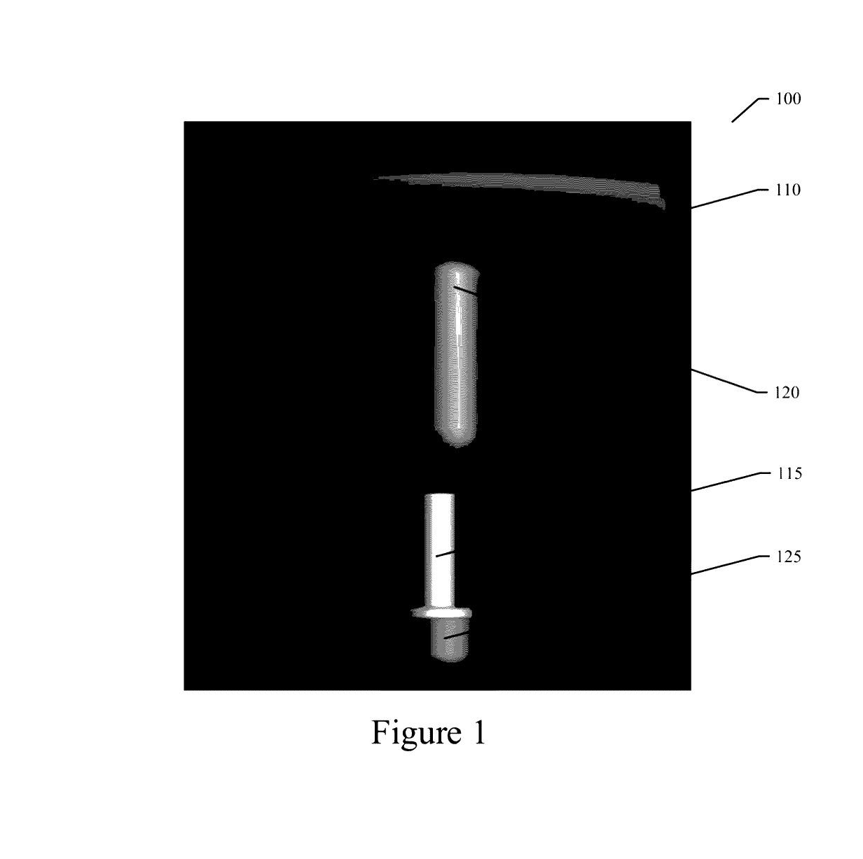

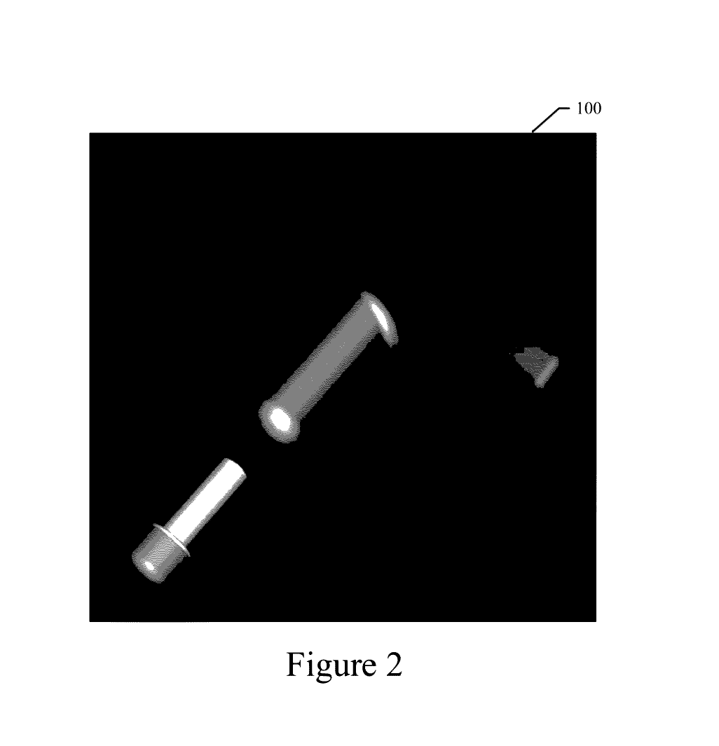

FIGS. 1 through 5 illustrate an example embodiment of an apparatus 100 for self-regulating therapeutic pressure massage. FIG. 1 illustrates a front and rear view of the apparatus 100 for self-regulating therapeutic pressure massage according to an example embodiment. FIG. 2 illustrates a perspective view of the apparatus 100 for self-regulating therapeutic pressure massage according to an example embodiment. Referring now to FIGS. 1 and 2, the example embodiment 100 comprises a T-shaped handle 110 with a rod 115 and an internal force self-regulating mechanism 120. In an example embodiment, the internal force self-regulating mechanism 120 can be a spring, an elastic band, an air or fluid chamber, an elastomeric material, or other force self-regulating mechanism. The handle 110 is designed for placement in the palm of the hand, or for mounting to a wall. A user may grasp the handle 110 and apply force to an area on the body for pain relief. The internal force self-regulating mechanism 120 varies the rate of pressure applied by the user to the body, and ensures that excessive force is not applied. The rod 115 utilizes a rounded, rubberized tip 125 on its terminal end and directs the force applied by the user to particular locations on the body. Various example embodiments can provide several alternative attachable tips for different parts of the body. A bigger sized tip can be used for a bigger area of the body. The tip as disclosed herein in an example embodiment is a general purpose, comfortable tip that can be used on a variety of body parts and can be manufactured in a simple and affordable manner. It will be apparent to those of ordinary skill in the art that references to the tip herein as disclosed for a particular example embodiment include all different forms of alternative attachable tips.

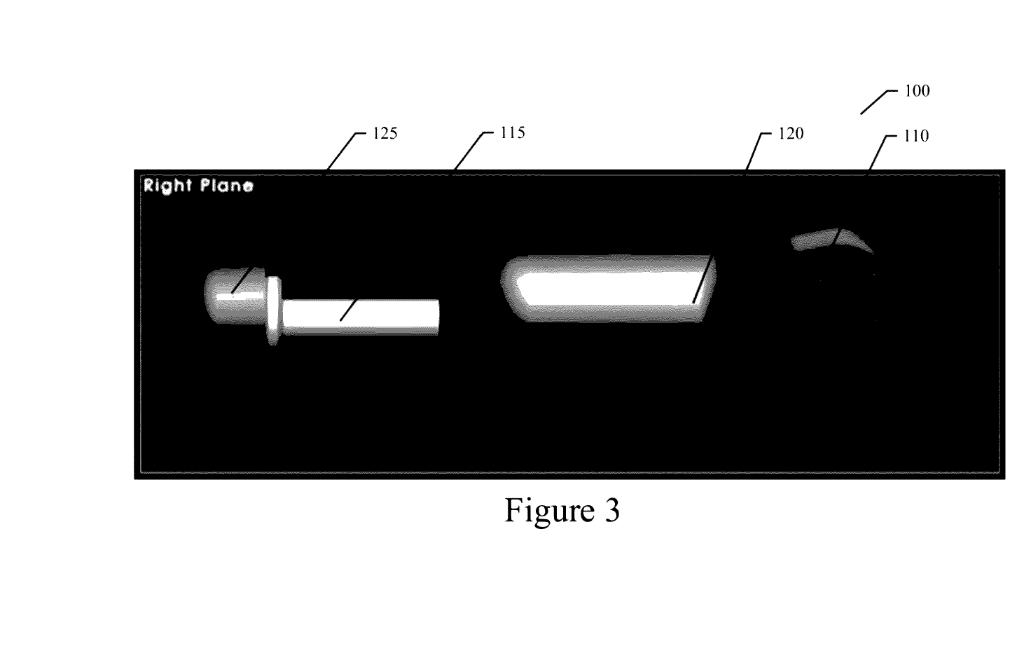

FIG. 3 illustrates a left and right side view of the apparatus 100 for self-regulating therapeutic pressure massage according to an example embodiment. Referring now to FIG. 3, there is shown a side view of the example embodiment. The force self-regulating mechanism 120 is contained within the T-shaped handle 110, and is in contact with a portion of the handle on a first end, and with the rod 115 on a second end. As described above, the force self-regulating mechanism 120 can be a spring. Springs containing different force or resistance constants can be used, which varies the amount of pressure applied through the rod 115. Alternatively, the force self-regulating mechanism 120 may be replaced with rubber bands, an elastic material, or an elastomeric material. The apparatus 100 can also incorporate a vibrating mechanism for added soft tissue stimulation.

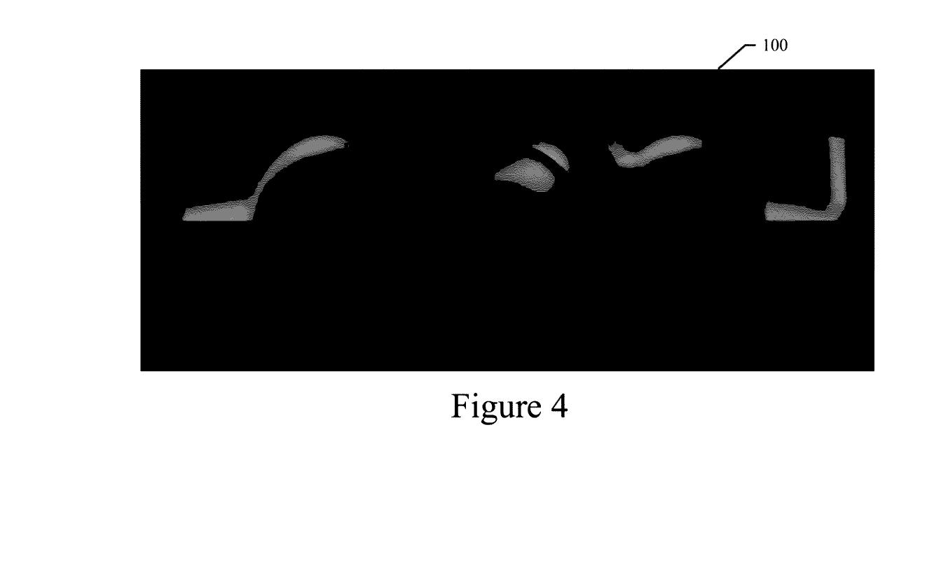

FIG. 4 illustrates a bottom view of the apparatus for self-regulating therapeutic pressure massage according to an example embodiment. Referring now to FIG. 4, as the user applies force to the handle 110 of the apparatus 100, the rod 115 slides into the handle 110, which compresses the force self-regulating mechanism 120. The compression of the force self-regulating mechanism 120 absorbs a portion of the force applied from the user, which prevents excessive pressure from being directed to the body. Additionally, the force self-regulating mechanism 120 enables a user to apply varying rates of pressure to specific regions of the body.

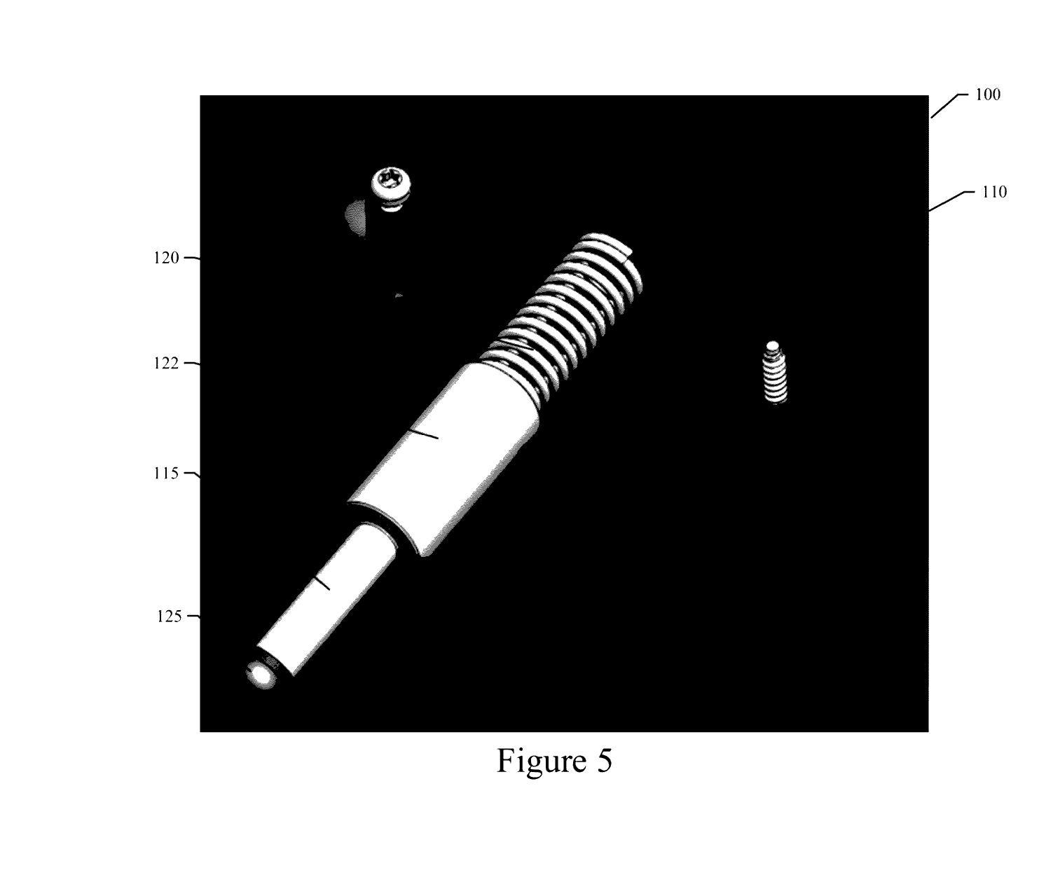

FIG. 5 illustrates a cutaway perspective view of the apparatus for self-regulating therapeutic pressure massage according to an example embodiment. Referring now to FIG. 5, there is shown a view of the internal force self-regulating mechanism 120 within the handle 110. As described above, as the user applies force to the handle 110 of the apparatus 100 while the tip 125 is in contact with a body part, the rod 115 slides into a sleeve 122 retained within the handle 110, which compresses the force self-regulating mechanism 120 contained in the sleeve 122. Alternatively, the rod 115 can be attached to the sleeve 122 at one end. When force is applied to the handle 110, the rod 115 and attached sleeve 122 compresses the force self-regulating mechanism 120 contained in the sleeve 122. The force self-regulating mechanism 120 is compressed because the mechanism 120 is in contact with a portion of the handle 110 on a first end of the mechanism 120, and with the rod 115 or sleeve 122 on a second end of the mechanism 120. As the rod 115 slides into the sleeve 122 or the rod 115 and sleeve 122 move within the handle 110, the rod 115 pushes the second end of the mechanism 120 toward the first end of the mechanism 120. As a result, mechanical energy is absorbed by the force self-regulating mechanism 120 and the force or pressure applied by the apparatus 100 to the body part is self-regulated.

The apparatus 100 can be used by hand or mounted to the wall. When mounted to the wall, a user aligns the apparatus 100 with the desired area of the body, and moves the body part towards the apparatus 100. The wall supports the handle in a stationary position, while the force self-regulating mechanism 120 compresses due to the movement of the body towards the apparatus 100. To vary the amount of pressure being applied to the body, the user can move closer to the wall for additional pressure, or further away from the wall to decrease the amount of pressure. In this way, the various example embodiments provide individuals with a simple way to release tension and stress from their muscles, joints, and body.

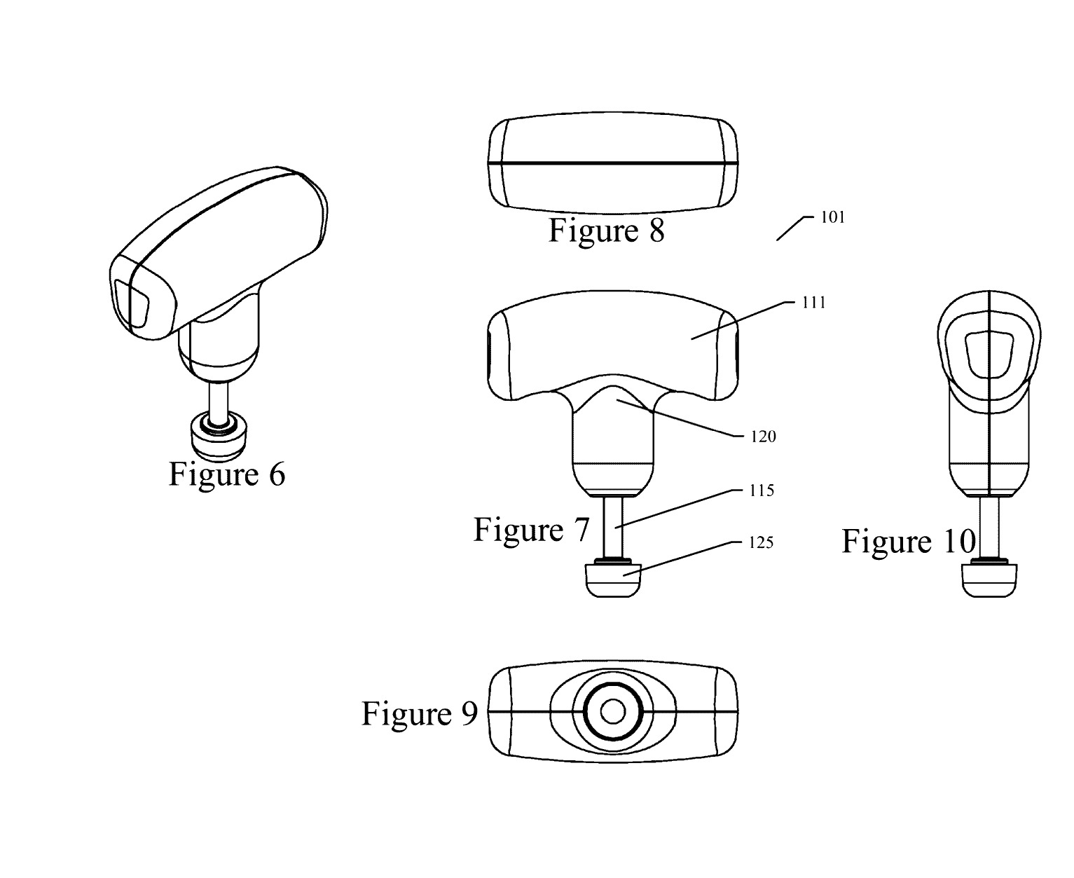

FIGS. 6 through 11 illustrate views of an alternative embodiment of the apparatus 101 for self-regulating therapeutic pressure massage with a T-shaped handle 111 according to an example embodiment. FIG. 6 illustrates a perspective view of an alternative embodiment of the apparatus 101 for self-regulating therapeutic pressure massage with a T-shaped handle 111 according to an example embodiment. FIG. 7 illustrates a front and rear view of an alternative embodiment of the apparatus 101 for self-regulating therapeutic pressure massage with a T-shaped handle 111 according to an example embodiment. FIG. 8 illustrates a top view of an alternative embodiment of the apparatus 101 for self-regulating therapeutic pressure massage with a T-shaped handle 111 according to an example embodiment. FIG. 9 illustrates a bottom view of an alternative embodiment of the apparatus 101 for self-regulating therapeutic pressure massage with a T-shaped handle 111 according to an example embodiment. FIG. 10 illustrates a left and right side view of an alternative embodiment of the apparatus 101 for self-regulating therapeutic pressure massage with a T-shaped handle 111 according to an example embodiment. FIG. 11 illustrates a cutaway front view of an alternative embodiment of the apparatus 101 for self-regulating therapeutic pressure massage with a T-shaped handle 111 according to an example embodiment.

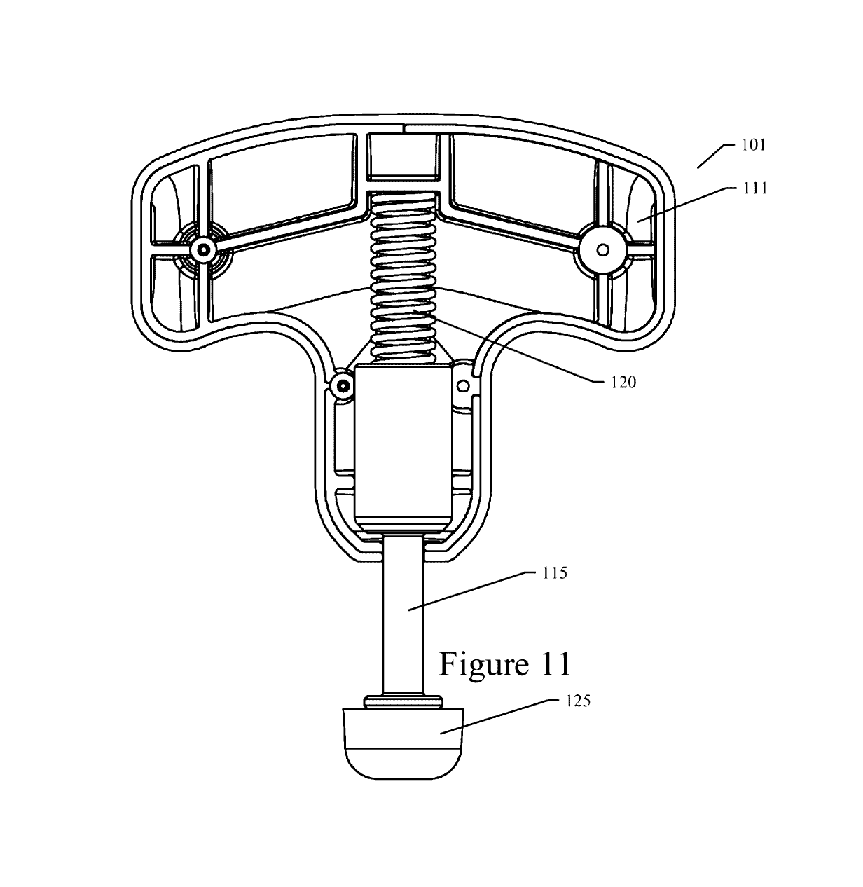

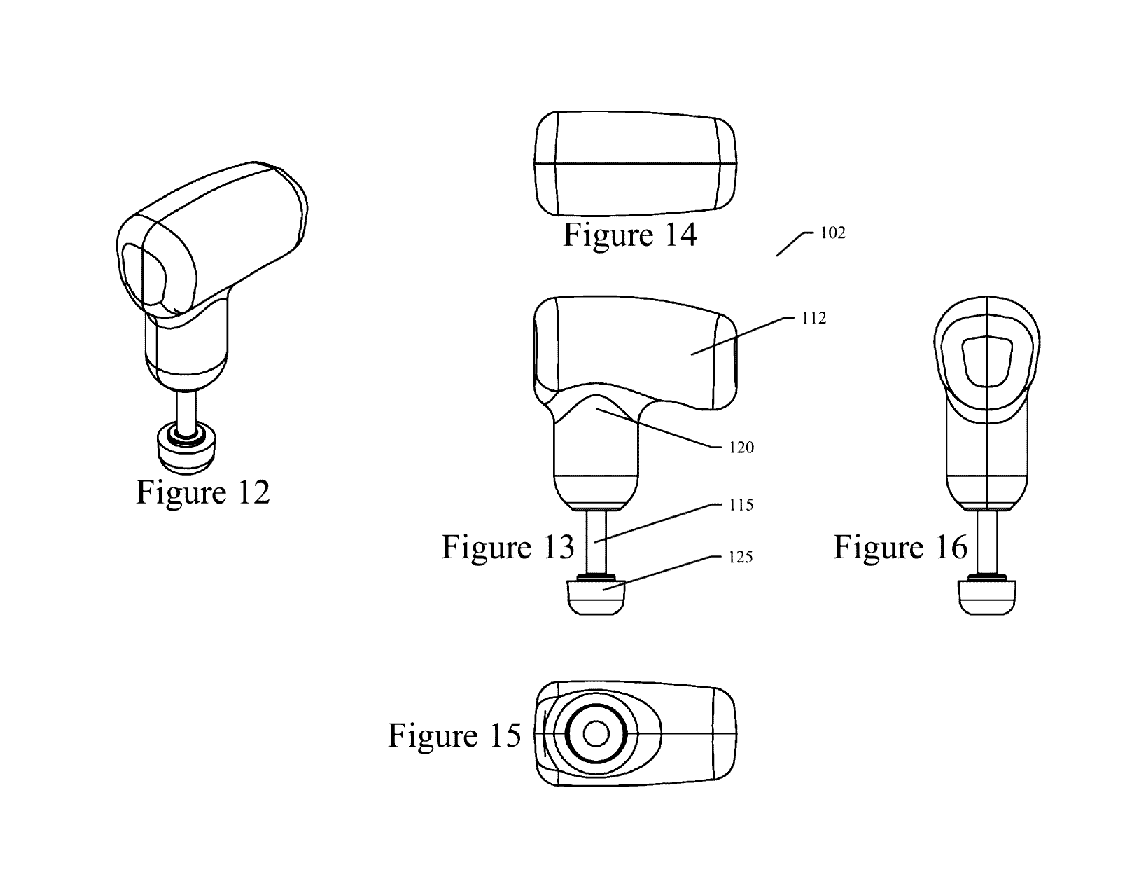

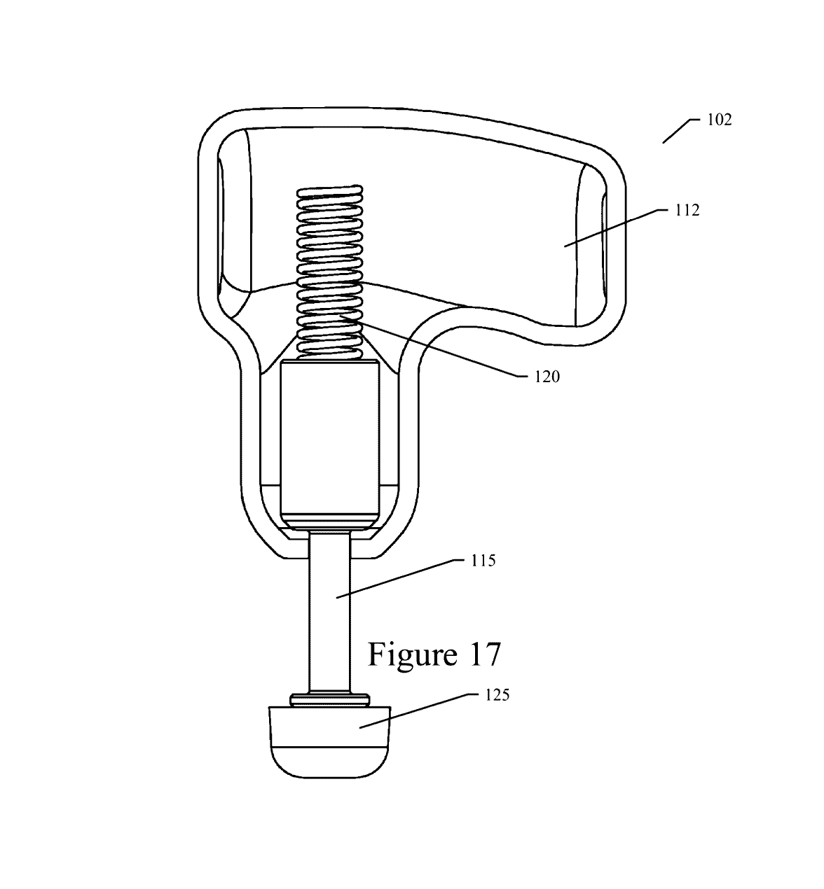

FIGS. 12 through 17 illustrate views of an alternative embodiment of the apparatus 102 for self-regulating therapeutic pressure massage with an L-shaped handle 112 according to an example embodiment. FIG. 12 illustrates a perspective view of an alternative embodiment of the apparatus 102 for self-regulating therapeutic pressure massage with an L-shaped handle 112 according to an example embodiment. FIG. 13 illustrates a front and rear view of an alternative embodiment of the apparatus 102 for self-regulating therapeutic pressure massage with an L-shaped handle 112 according to an example embodiment. FIG. 14 illustrates a top view of an alternative embodiment of the apparatus 102 for self-regulating therapeutic pressure massage with an L-shaped handle 112 according to an example embodiment. FIG. 15 illustrates a bottom view of an alternative embodiment of the apparatus 102 for self-regulating therapeutic pressure massage with an L-shaped handle 112 according to an example embodiment. FIG. 16 illustrates a left and right side view of an alternative embodiment of the apparatus 102 for self-regulating therapeutic pressure massage with an L-shaped handle 112 according to an example embodiment. FIG. 17 illustrates a cutaway front view of an alternative embodiment of the apparatus 102 for self-regulating therapeutic pressure massage with an L-shaped handle 112 according to an example embodiment.

As shown in FIGS. 5, 11, and 17, the example embodiments can be fabricated by producing a handle with two halves that can be attached together with screws, glue, or other attachment means. The force self-regulating mechanism 120, a portion of the rod 115, and the sleeve 122 can be captured within the two halves of the handle as shown and described herein. As a result, the handle can be used by a user to transfer force through the force self-regulating mechanism 120, the rod 115, and the tip 125 to deliver a self-regulated level of pressure to a desired body part for therapeutic massage therapy. The handle can be produced from various materials including: plastic, metal, wood, rubber, composites, or other readily manufacturable materials. The handle is contoured to fit comfortably in the hand. In the various disclosed embodiments, the configuration of the handle is appropriate for self-application or use of the device on oneself This allows efficiency and comfort while the self-application is taking place.

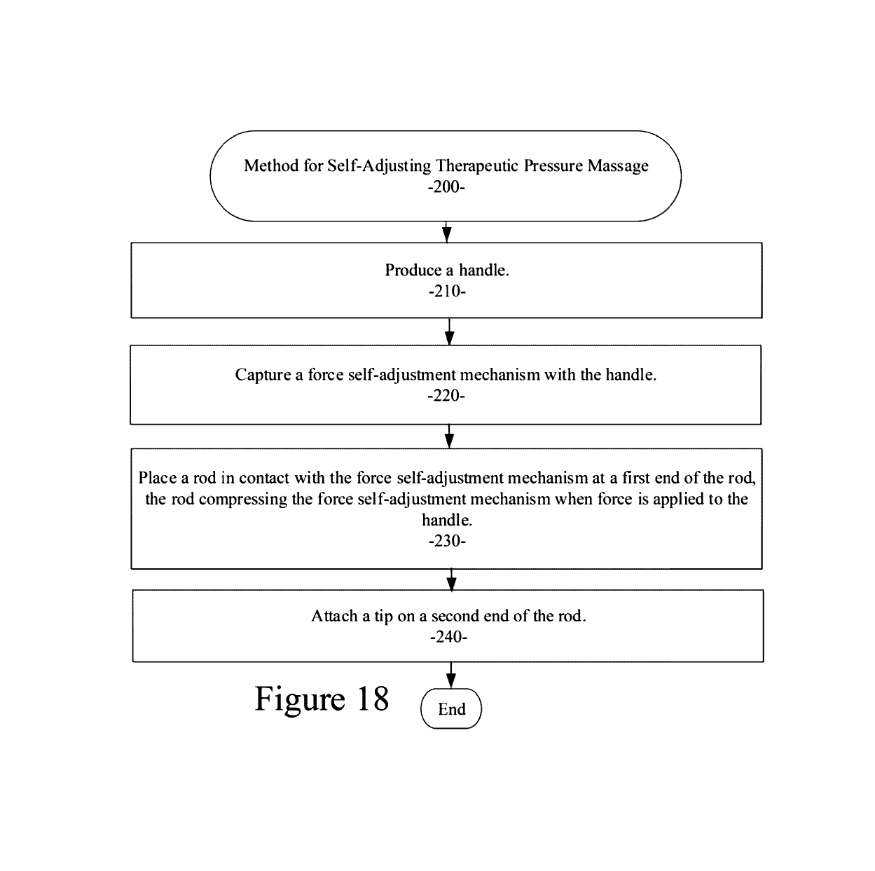

Referring now to FIG. 18, a flow diagram illustrates an example embodiment of a method for self-regulating therapeutic pressure massage as described herein. The method 200 of an example embodiment includes: producing a handle (operation 210); capturing a force self-regulating mechanism with the handle (operation 220); placing a rod in contact with the force self-regulating mechanism at a first end of the rod, the rod compressing the force self-regulating mechanism when force is applied to the handle (operation 230); and attaching a tip on a second end of the rod (operation 240).

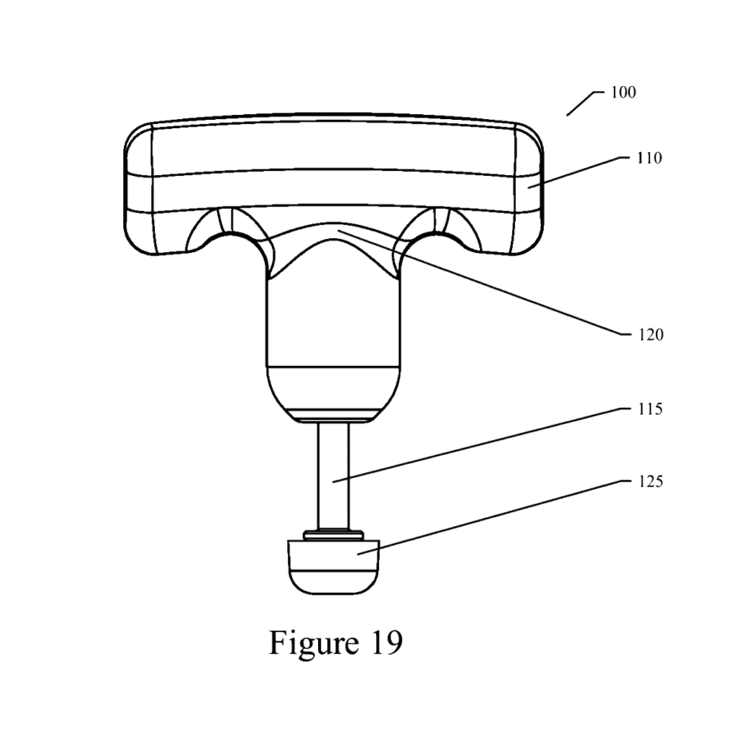

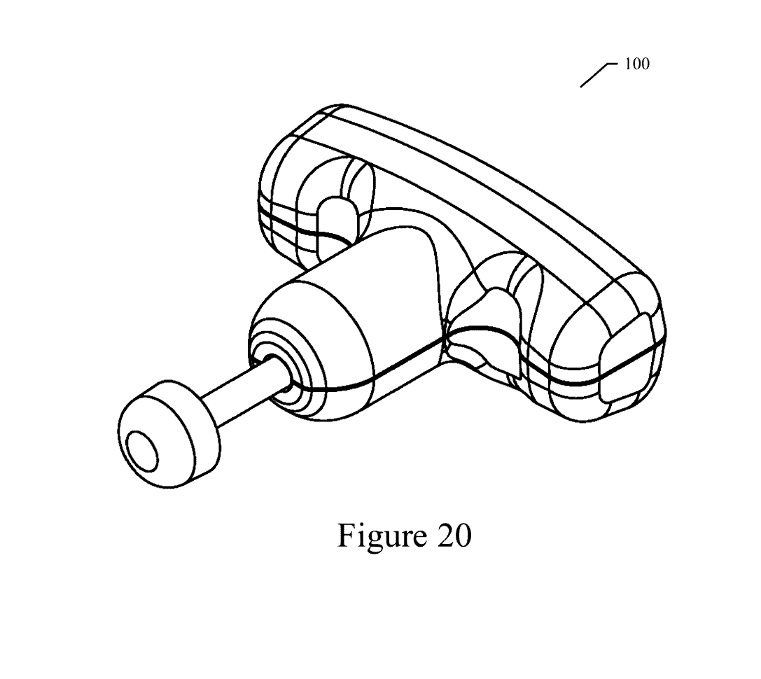

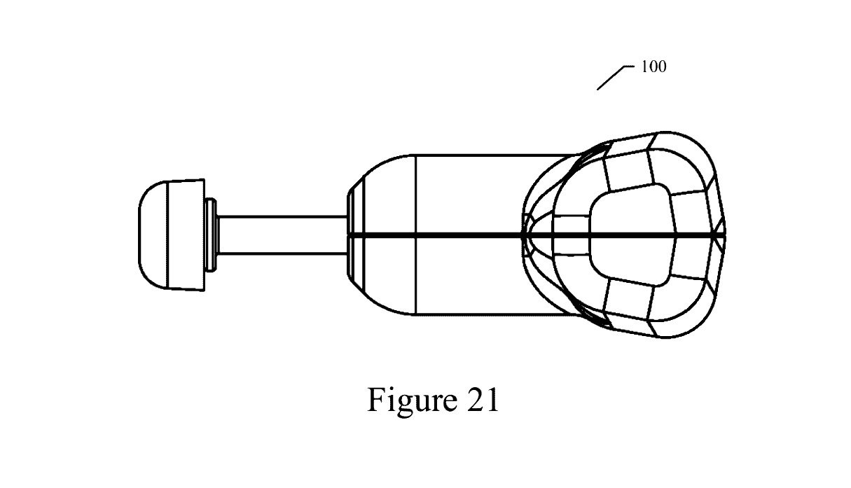

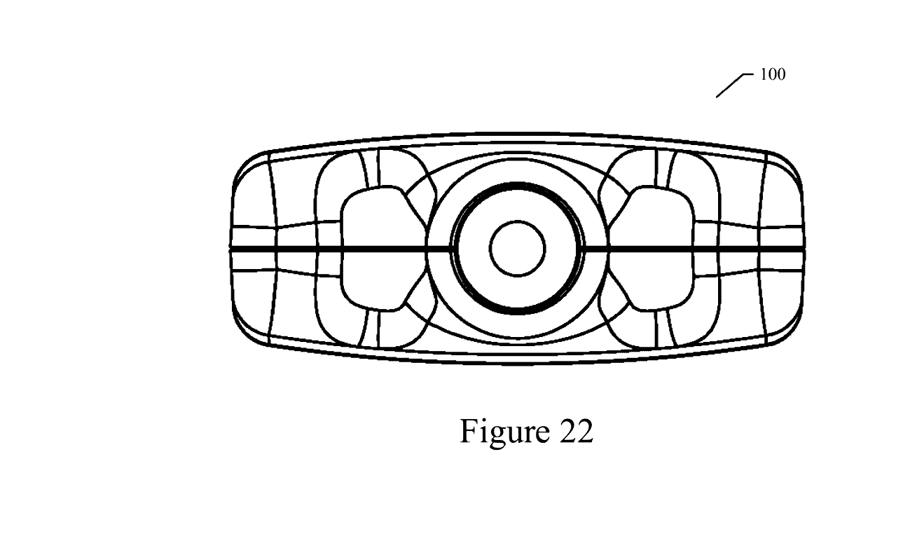

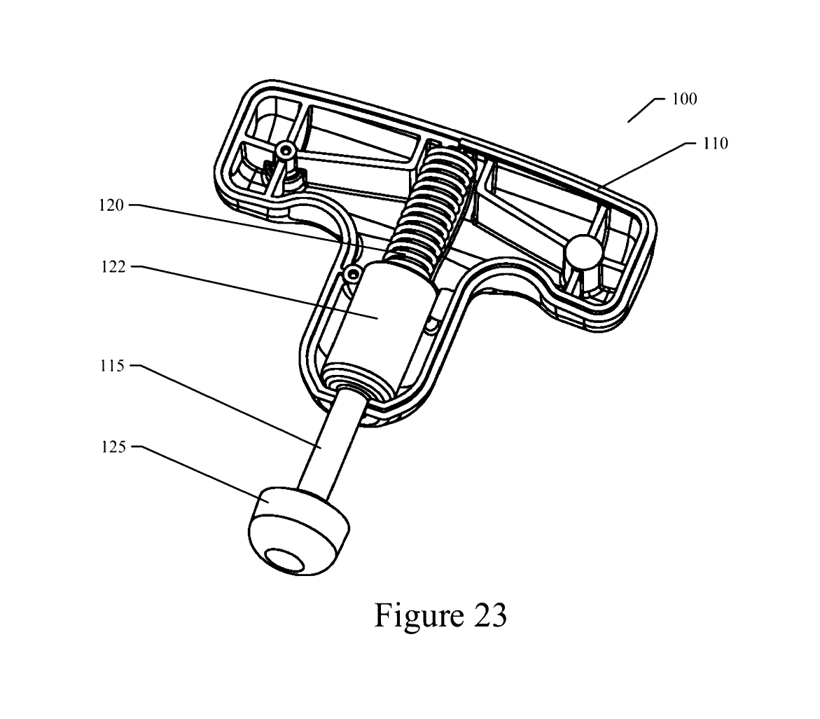

FIGS. 19 through 23 illustrate alternative views of the apparatus for self-regulating therapeutic pressure massage according to the example embodiment shown in FIGS. 1 through 5. For example, FIG. 19 illustrates an alternative of the front and rear view of an apparatus for self-regulating therapeutic pressure massage according to an example embodiment. FIG. 20 illustrates an alternative of the perspective view of an apparatus for self-regulating therapeutic pressure massage according to an example embodiment. FIG. 21 illustrates an alternative of the left and right side view of an apparatus for self-regulating therapeutic pressure massage according to an example embodiment. FIG. 22 illustrates an alternative of the bottom view of an apparatus for self-regulating therapeutic pressure massage according to an example embodiment. FIG. 23 illustrates an alternative of the cutaway perspective view of an apparatus for self-regulating therapeutic pressure massage according to an example embodiment.

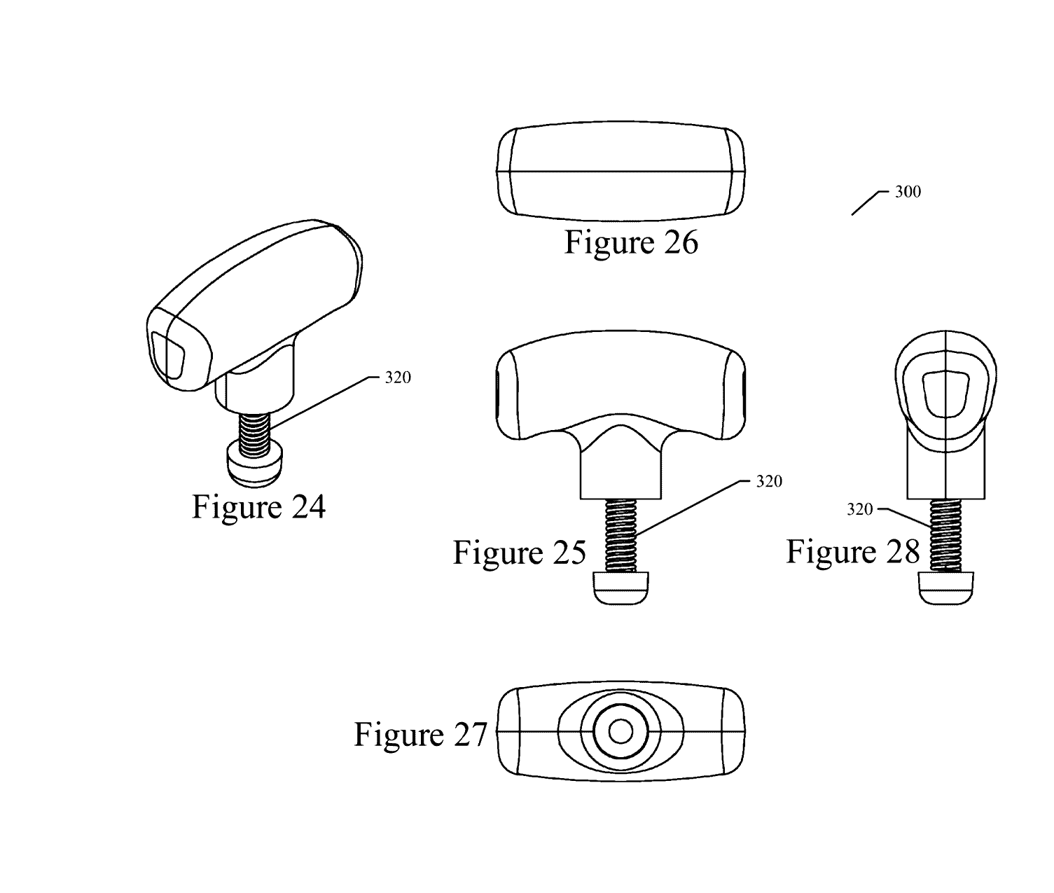

FIGS. 24 through 28 illustrate an alternative embodiment 300 of the apparatus for self-regulating therapeutic pressure massage wherein the force self-regulating mechanism replaces the rod provided in other embodiments. In this configuration, the force self-regulating mechanism 320 connects directly between the handle and the tip of the self-regulating therapeutic pressure massage apparatus 300. In particular, FIG. 24 illustrates a perspective view of an alternative embodiment of the apparatus for self-regulating therapeutic pressure massage wherein the force self-regulating mechanism replaces the rod according to an example embodiment. FIG. 25 illustrates a front and rear view of an alternative embodiment of the apparatus for self-regulating therapeutic pressure massage wherein the force self-regulating mechanism replaces the rod according to an example embodiment. FIG. 26 illustrates a top view of an alternative embodiment of the apparatus for self-regulating therapeutic pressure massage wherein the force self-regulating mechanism replaces the rod according to an example embodiment. FIG. 27 illustrates a bottom view of an alternative embodiment of the apparatus for self-regulating therapeutic pressure massage wherein the force self-regulating mechanism replaces the rod according to an example embodiment. FIG. 28 illustrates a left and right side view of an alternative embodiment of the apparatus for self-regulating therapeutic pressure massage wherein the force self-regulating mechanism replaces the rod according to an example embodiment.

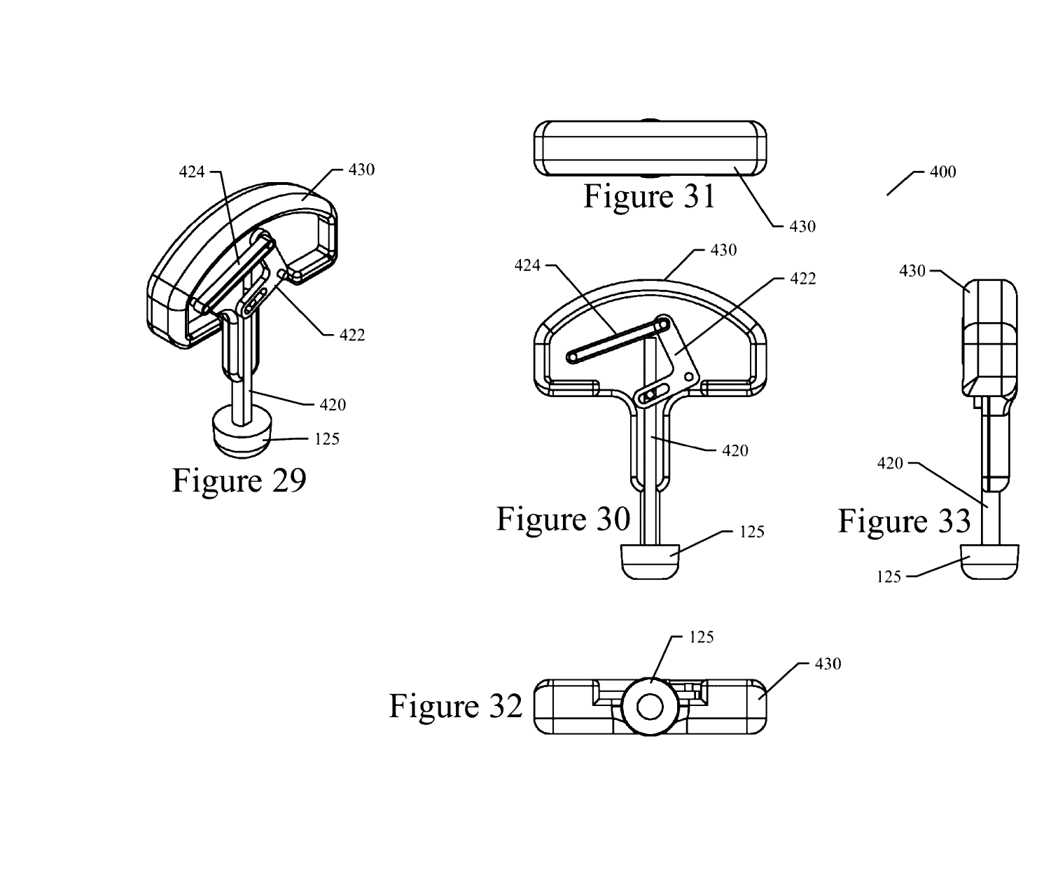

FIGS. 29 through 33 illustrate an alternative embodiment 400 of the apparatus for self-regulating therapeutic pressure massage wherein the force self-regulating mechanism is in an externally-accessible, lever-actuated configuration. In this embodiment, the self-regulating therapeutic pressure massage apparatus 400 provides a rod 420 on which a tip 125 can be attached at one end. The other end of rod 420 is connected to a lever or cam 422 that pivots as pressure is applied to the tip 125 and the rod 420 is pushed into the handle 430. The lever 422 is connected to a tensioning mechanism 424, such as an elastic band, a spring, or other tension-providing device. As lever 422 pivots, the tensioning mechanism 424 is stretched, which serves to apply pressure to the lever 422 to resist the movement of the rod 420 into the handle 430. Thus, the combination of the lever 422 and the tensioning mechanism 424 of the self-regulating therapeutic pressure massage apparatus 400 provides a force self-regulating mechanism in the illustrated embodiment. In this embodiment as shown, a portion of handle 430 can be left uncovered so the tensioning mechanism 424 is externally accessible. This configuration allows a user to insert a tensioning mechanism 424 into the apparatus 400 without disassembling the device. This configuration also allows a user to insert tensioning mechanisms 424 with different elastic properties. For example, elastic bands or springs with different elastic strengths can be readily inserted into the apparatus 400 to vary the operational characteristics of the force self-regulating mechanism of the apparatus 400. This provides an apparatus with a variable force self-regulating mechanism. In particular, FIG. 29 illustrates a perspective view of an alternative embodiment of the apparatus for self-regulating therapeutic pressure massage providing an externally-accessible, lever-actuated force self-regulating mechanism according to an example embodiment. FIG. 30 illustrates a front and rear view of an alternative embodiment of the apparatus for self-regulating therapeutic pressure massage providing an externally-accessible, lever-actuated force self-regulating mechanism according to an example embodiment. FIG. 31 illustrates a top view of an alternative embodiment of the apparatus for self-regulating therapeutic pressure massage providing an externally-accessible, lever-actuated force self-regulating mechanism according to an example embodiment. FIG. 32 illustrates a bottom view of an alternative embodiment of the apparatus for self-regulating therapeutic pressure massage providing an externally-accessible, lever-actuated force self-regulating mechanism according to an example embodiment. FIG. 33 illustrates a left and right side view of an alternative embodiment of the apparatus for self-regulating therapeutic pressure massage providing an externally-accessible, lever-actuated force self-regulating mechanism according to an example embodiment.

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, an apparatus and method for self-regulating therapeutic pressure massage are disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. An apparatus comprising:
a handle;
a force self-regulating mechanism captured with the handle;
a rod in contact with the force self-regulating mechanism at a first end of the rod, the rod compressing the force self-regulating mechanism when force is applied to the handle; and
a tip attached to a second end of the rod.

2. The apparatus of claim 1 wherein the handle is T-shaped.

3. The apparatus of claim 1 wherein the handle is L-shaped.

4. The apparatus of claim 1 wherein the force self-regulating mechanism is of a type from the group consisting of: a spring, an elastic band, an elastomeric material, and a lever or cam.

5. The apparatus of claim 1 wherein the force self-regulating mechanism is externally accessible.

6. The apparatus of claim 1 including a sleeve, a portion of the force self-regulating mechanism being captured within the sleeve.

7. The apparatus of claim 1 wherein the tip is fabricated from a pliable material.

8. The apparatus of claim 1 wherein the tip is rounded.

9. A method comprising:
producing a handle;
capturing a force self-regulating mechanism with the handle;
placing a rod in contact with the force self-regulating mechanism at a first end of the rod, the rod compressing the force self-regulating mechanism when force is applied to the handle; and
attaching a tip on a second end of the rod.

10. The method of claim 9 wherein the handle is T-shaped.

11. The method of claim 9 wherein the handle is L-shaped.

12. The method of claim 9 wherein the force self-regulating mechanism is of a type from the group consisting of: a spring, an elastic band, an elastomeric material, and a lever or cam.

13. The method of claim 9 wherein the force self-regulating mechanism is externally accessible.

14. The method of claim 9 including capturing a portion of the force self-regulating mechanism within a sleeve.

15. The method of claim 9 wherein the tip is fabricated from a pliable material.

16. The method of claim 9 wherein the tip is rounded.

17. An apparatus comprising:
a handle;
a force self-regulating mechanism captured with the handle at a first end of the force self-regulating mechanism, the force self-regulating mechanism being compressed when force is applied to the handle; and
a tip attached to a second end of the force self-regulating mechanism.

18. The apparatus of claim 17 wherein the handle is T-shaped.

19. The apparatus of claim 17 wherein the handle is L-shaped.

20. The apparatus of claim 17 wherein the tip is fabricated from a rounded, pliable material.
